(19) United States
(12) Patent Application Publication
(10) Pub. No.: US 2009/0291214 A1
(43) Pub. Date: Nov. 26, 2009

(54) PROTEIN INKS OF COLLOIDAL IMMOBILIZED PROTEINS

(75) Inventor: Chenghong Lei, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute

(21) Appl. No.: 12/126,277

(22) Filed: May 23, 2008

(51) Int. Cl. C09D 11/04; B32B 9/00; B05D 1/02; B05D 1/00; B05D 1/30

(52) U.S. Cl. 427/256; 427/421.1; 427/420; 106/31.13; 524/17

(57) ABSTRACT

Protein inks made up of proteinated or enzymatic nanoparticles dispersed in liquid solution as a colloid can be printed or coated upon a variety of types of substrates to create a variety of types of products. Examples include, protein microarrays, biochips, biosensors and biochemical reactors. In one application, these immobilized protein inks form three-dimensional bioactive coatings that demonstrate increased stability and sensitivity as compared to other types of protein immobilizing strategies.

### FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

1. Field of the Invention

The invention generally relates to bioactive materials and more particularly to immobilized bioactive nanomaterials that can be applied in various ways, including providing three dimensional deposits on substrates for testing.

2. Background Information

Protein microarrays have been used for a variety of screening procedures and the qualitative and quantitative analysis of a variety of substances, analytes, metabolites, and biomarkers. A variety of different substrates such as glass slides have been used to make these protein microarrays because of their ease of use, relatively high durability, optical properties, and the ability allowing devices such as robotic spotters to generate high-density arrays. However, these conventional protein microarrays typically require complicated attachment chemistry and/or allow only one monolayer of proteins to attach on the substrate surface. This results in a decreased density of the proteins (herein also include enzymes, antibodies, or their complexes) that can be attached to the substrate surface, and correspondingly a decreased sensitivity of the protein microarray themselves. In addition, not all proteins remain functional in these conventional microarray formats due to the harsh attachment conditions. Because of only allowing small amount of active protein available, the conventional monolayer attachment chemistry often results a large data variation even from small variations of the experimental conditions such as surface inhomogeneity. Therefore, the reproducibilities, stabilities and sensitivities of the conventional protein microarrays are limited. What is needed therefore is an array and a method of making an array that overcomes these limitations and provides increased protein functionality, stability and sensitivity. The present invention meets these needs.

Additional advantages and novel features of the present invention will be set forth as follows and will be readily apparent from the descriptions and demonstrations set forth herein. Accordingly, the following descriptions of the present invention should be seen as illustrative of the invention and not as limiting in any way.

### SUMMARY

The present invention is a new concept of immobilized proteins dispersed in liquid solution as a colloid, referred to as protein inks. The protein inks are comprised of proteinated nanoparticles and thus printable or coatable upon a variety of types of substrates. Potential uses for such inks include, protein microarrays, biochips, biosensors and biochemical reactors. In one application, these immobilized protein inks can be utilized to form a three-dimensional bioactive coating made up of a deposition of an immobilized protein ink having at least one protein immobilized between a plurality of nanoscaled particles. These immobilized proteins are dispersed in a colloidal aqueous solution of nanomaterials where the protein molecules would be incorporated, intercalated, entrapped or encapsulated with the nanomaterials.

The colloidally immobilized proteins, or protein inks, can be directly applied by a method such as printing onto substrates such as glass slides in a high-density organization for making highly sensitive and high throughput protein microarrays in a rapid and reproducible manner. The protein availability in these protein ink-formed three-dimensional films or membranes on the substrate is much higher than that of a single monolayer protein on the substrate using conventional monolayer attachment technology. The reproducibility, stability, and sensitivity of the proposed protein microarray based on this invention are significantly greater than those that use conventional technology.

In some embodiments of the invention, the three-dimensional bioactive coating includes nanoscaled particles that may be either porous or non-porous and typically have dimensions in the range of 1-1000 nanometers. These nanoparticles are made from materials such as mineral or synthesized clays, silica, metal oxides, metal hydroxides, metal salts, and combinations of these materials. Examples of these types of clay, include but are not limited to, Montmorillonite, Kaolinite, Palygorskite (attapulgite), Hectorite, Ripidolite, Rectorite, Laponite, Illite, Smectite, Ferruginous Smectite, Nontronite, Cookeite, Beidellite, Sepiolite, Saponite, Vermiculite, various synthesized clays and combinations thereof. Examples of the metal oxides include, but are not limited to, TiO₂, Fe₂O₃, V₂O₅, ZnO, Al₂O₃, MgO. Examples of metal hydroxide nanoparticles that may be included in the present invention include, but are not limited to, Fe(OH)₃, Zn(OH)₂, Al(OH)₃, Mg(OH)₂. and combinations thereof. Examples of metal salt nanoparticles that may be included in various embodiments of the present invention include, but are not limited to, metal phosphates, metal silicates, metal sulfates, metal carbonates and combinations thereof. While the following materials and types of materials have been described above, it is to be distinctly understood that the invention is not limited to these particular recited examples, but may be variously configured and embodied to include a variety of other types of features, devices and advantages. This includes embodiments where the nanoparticles of a generally uniform or non-uniform size.

In addition, in some embodiments of the invention the nanoparticles are functional or functionalized with a particular functional group. Examples of such functional groups, include but are not limited to,: —NH₂, —COOH, —SO₃H, —SH, —CN, —OH and combinations thereof. In some embodiments of the invention, these inks comprise a mixture of bioactive particles comprising said at least one protein immobilized between a plurality of nanoparticles dispersed in a dispersing liquid. This dispersing liquid can be an aqueous buffer solution and may contain any of a variety of dispersing additives including examples selected from the group consisting of: polyamino acids, ionic surfactants, non-ionic surfactants, functional polymers, biomacromolecules and combinations thereof. These inks can then be dispersed upon any of a variety of substrates for making microarrays, biosensors, biochips, biomembranes, bioreactors, chemical reactors, and combinations thereof, in a variety of ways including but not limited to printing, coating, spraying, pouring and combinations thereof. While this aforementioned list has been provided, it is to be distinctly understood that the invention is not limited thereto but may be variously alternatively embodied according to the needs and necessities of a user.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, I have shown and described only the preferred embodiment of the invention, by way of illustration of the best mode contemplated for carrying out the invention. As will be realized, the invention is capable of modification in various respects without departing from the invention. Accordingly, the drawings and description of the preferred embodiment set forth hereafter are to be regarded as illustrative in nature, and not as restrictive.

### BRIEF DESCRIPTION OF THE DRAWINGS

FIG. 1 is a perspective conceptual view of a first embodiment of the present invention

FIG. 2A shows photo images of horseradish peroxidase (HRP) protein inks based on Titanium oxide (TOD) colloidal nanoparticles dispersed in sodium phosphate buffer.

FIGS. 2B & 2C show the UV-visible spectra (B) and enzyme activities (C) of HRP in the presence and absence of the TOD colloidal nanoparticles.

FIG. 3A & 3B show comparison of fluorescent images of the HRP microarray using conventional monolayer immobilization technology with that using the HRP-TOD protein ink technology. FIG. 3C shows comparison of the fluorescence intensities of the microarray spots for the HRP and HRP-TOD samples.

FIG. 4A shows the texture of Horseradish peroxidase-Titanium oxide colloidal nanoparticles imaged by TEM.

FIG. 4B shows AFM height image of HRP-TOD membrane on a glass cover slip.

### DETAILED DESCRIPTION OF THE INVENTION

The following description includes the preferred best mode of one embodiment of the present invention. It will be clear from this description of the invention that the invention is not limited to these illustrated embodiments, but that the invention also includes a variety of modifications and embodiments thereto. Therefore the present description should be seen as illustrative and not limiting. While the invention is susceptible of various modifications and alternative constructions, it should be understood that there is no intention to limit the invention to the specific form disclosed, but, on the contrary, the invention is to cover all modifications, alternative constructions, and equivalents falling within the spirit and scope of the invention as defined in the claims.

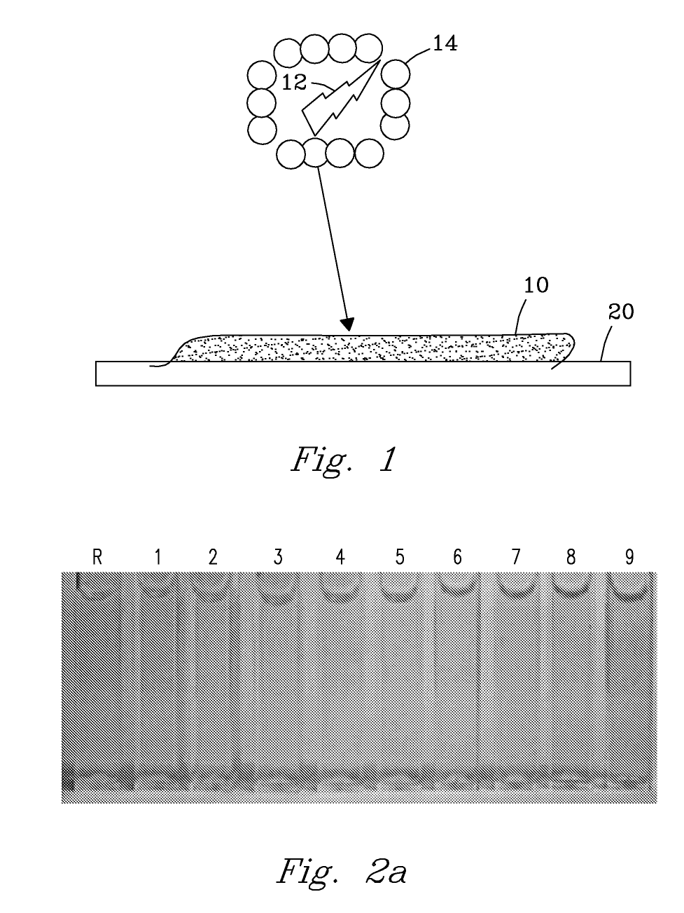

FIGS. 1-4 show a variety of embodiments of the present invention. Referring first to FIG. 1, a first view of one embodiment of the present invention is shown. In this first preferred embodiment of the invention, a three dimensional bioactive coating 10 made up of at least one protein 12 immobilized between a plurality of nanoparticles 14 is applied to a substrate 20. This active coating is preferably applied to the substrate in the form of a “protein ink” which includes these proteins 12 immobilized within a group of nanoscaled particles 14, preferably in a colloid form. This protein ink can then be sprayed on to a substrate 20 to deposit a bioactive coating upon the substrate directly without the use of harsh chemicals to adhere the coatings to the substrate 20.

In one embodiment of the invention, the nanoscaled particles 14 or nanoparticles are metal oxides (MOs) (including semimetal oxides such as SiO2) with inherent inorganic nanostructure. When dispersed in water, they are nanoparticles or nano sheets in a few to hundreds of nanometers, or polymeric networked sols, i.e. metal oxides colloids (MOCs) or metal oxide sols (MOSs). The nanoparticles or nanosheets of these metal oxides are usually prepared by hydrolysis of the corresponding metal salts or metallorganic compounds under acidic, basic, or neutral conditions followed by neutralization and/or dialysis against water or buffer solution. Similar to silica, some of MOs have abundant hydroxyl groups. MOs with abundant hydroxyl groups can be functionalized, e.g. with amino (NH2-), carboxyl (HOOC—), Mercapto (HS—), etc. groups to form functional metal oxides (FMO). FMO can be dispersed subsequently in aqueous solution into functional metal oxide colloid (FMOC). Examples of metal oxides include: TiO2, Fe2O3, V2O5, SiO2, ZnO, Al2O3, MgO, etc. The invention also includes corresponding metal hydroxides.

These metal oxides can usually exist in forms of aqueous sols which can be formed into gels after condensation. The inclusion of proteins, such as enzymes in the metal oxides sols, provides colloidal immobilized enzymes, and these immobilized enzymes can be printed or coated on the solid substrates to form highly stable and active enzymatic films/membranes for usages in thin films and coatings, chemical/biochemical engineering reactors, protein/enzyme, antibody/antigen microarrays, biosensors and other biochips.

Metal oxides are conveniently synthesized and easily standardized inorganic materials. These features will facilitate optimization of nanoparticle or nanosheet size or sol preparation, as well as functionalizations, so that proteins/enzymes will be immobilized in an environment that promotes enhanced stability and activity. Metal oxides and functionalized metal oxides can be prepared in appropriate particle sizes ranging from a few to several hundred nanometers or sols that facilitate formulation of “Ink”-like colloid, i.e. MO or FMO dispersed in aqueous solution.

When proteins (antibodies, enzymes) are incubated with MOC or FMOC, the proteins can be incorporated, encapsulated, entrapped, or intercalated in between MO or FMO nanoparticles or nanosheets or sols and accordingly immobilized. The thus immobilized enzymes are highly active and stable, dispersed in aqueous solution as a colloid, colloidal immobilized protein, i.e. an ink-like dispersion, MO or FMO-based Protein (Enzyme, or Antibody/Antigen) Ink. These colloidal immobilized proteins, protein inks, can be directly used for chemical/biochemical engineering reactors or protein microarrays. The protein inks can also be formed in a nanoscaled fine powder after condensing and drying. Dried powder of thus immobilized proteins can be re-dispersed in aqueous solution into “protein ink” colloid.

The protein inks, which are highly active and stable, can be easily applied to a working substrate, i.e, by simply “printing”, “microspotting” to make highly sensitive microarrays, which the bulk-sized immobilized proteins through conventional immobilization approaches could not do with. The protein (enzyme, antibody/antigen) inks resulted from this invention will be used for advanced microarrays, biosensors & biochips, ultrathin biomembranes & bioreactors. For instance, the sensitivity of the protein (enzyme, antibody/antigen) microarray based on this invention could be several to tens of times higher than that of the conventional microarrays based on monolayer of protein, enzyme or antibody/antigen attachment chemistry on the substrate, thanks to the formation of the thick, 3-dimensional films on the substrate based on the protein ink technology.

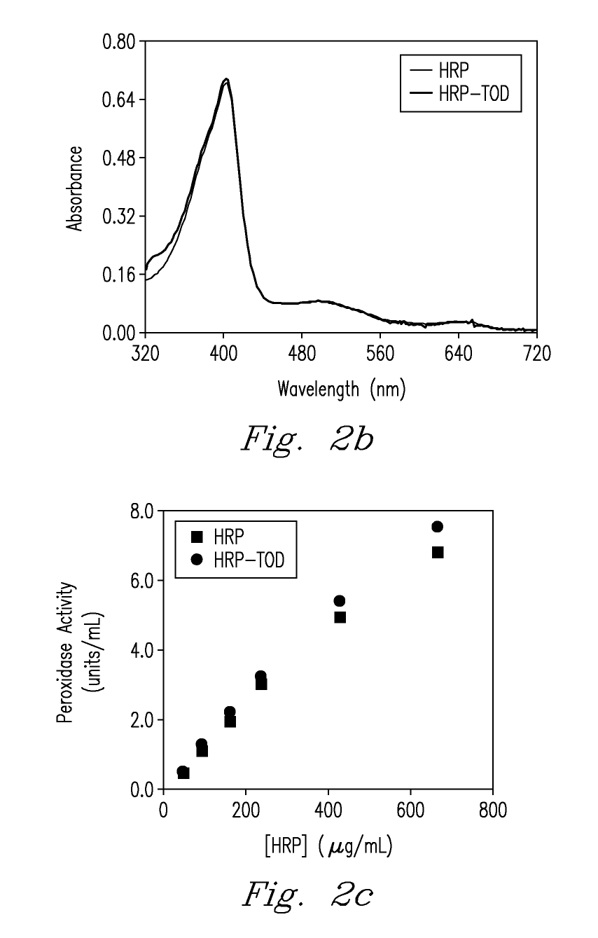

FIG. 2A shows photo images of horseradish peroxidase protein inks based on Titanium oxide colloidal nanoparticles dispersed in 4.2 mM sodium phosphate buffer. The resulting “Protein Inks” can be printable either by printer or micro-spotter into any desired pattern on a supporting substrate. These cuvettes contain from 0.0 to 0.7 mg/mL horseradish peroxidase in 4.2 mM sodium phosphate in presence of 80 μg/mL Titanium oxide nanoparticles from left to right. FIGS. 2B & 2C show the UV-visible spectra (B) and enzyme activities (C) of HRP in the presence and absence of the TOD colloidal nanoparticles.

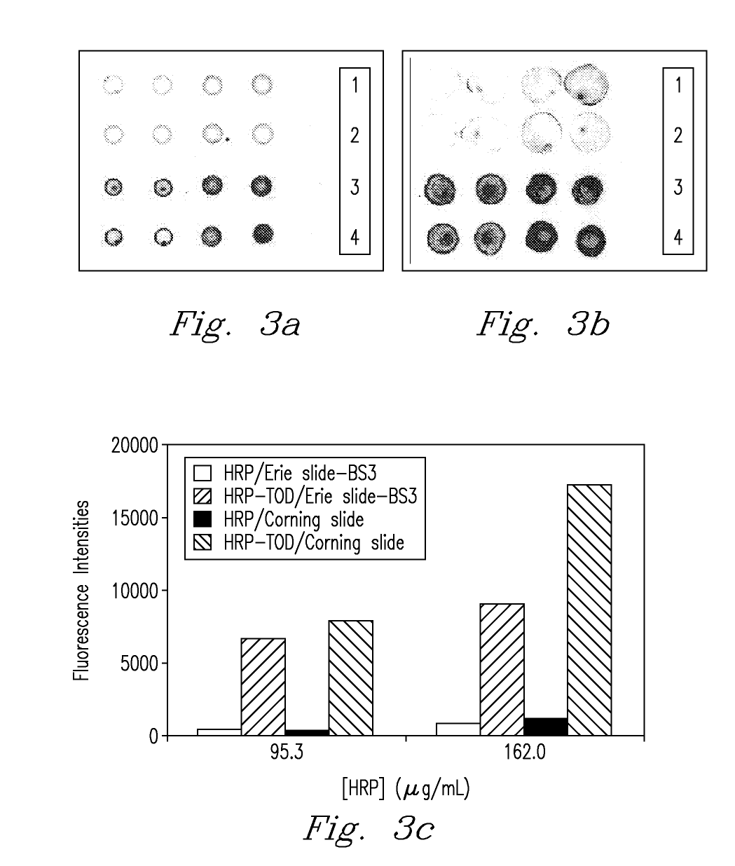

FIG. 3A & 3B show comparison of fluorescent images of the HRP microarray using conventional monolayer immobilization technology with that using the HRP-TOD protein ink technology. FIG. 3C shows comparison of the fluorescence intensities of the microarray spots for the HRP and HRP-TOD samples.

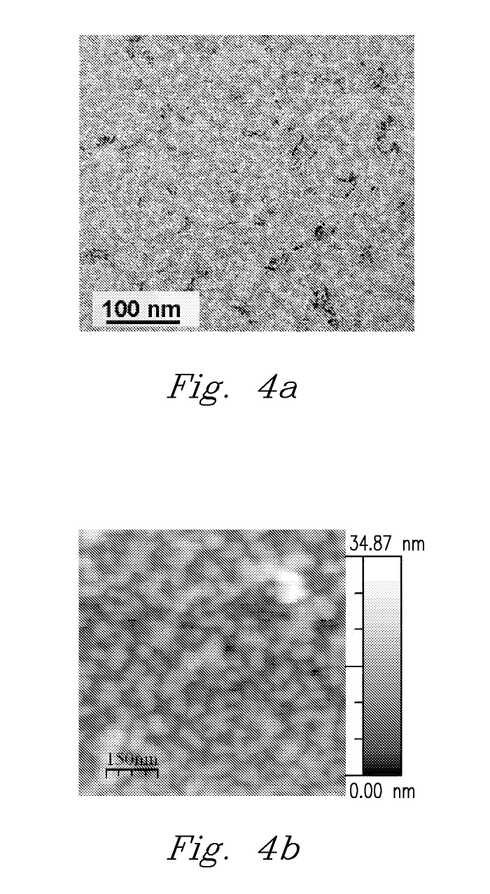

FIG. 4A shows the texture of Horseradish peroxidase-Titanium oxide colloidal nanoparticles imaged by TEM. FIG. 4B shows AFM height image of HRP-TOD membrane on a glass cover slip.

The description of this invention is a general approach, therefore it may be applicable to many proteins, enzymes, antibodies/antigens, or their complexes. In addition to the examples provided above, other examples have also been created and tested. These include Titanium Oxide (TOD); sodium montmorillonite colloid (SMC) as the nanoparticles for the proteins including horeseradish peroxidase (HRP); cytochrome C (CTC); myoglobin (MB); hemoglobin (HB); organophosphorus hydrolase (OPH); Shewanella outermembrane cytochromes (OMC); Anti-human TGF Antibody; Anti-human VEGF Antibody; Anti-human E-Selection/CD62E Antibody; Anti-human MMP-1 Antibody; Anti-human PDGF-AA Antibody; Anti-human CCL5/RANTES Antibody.

While bio thin films/coatings and protein microarrays have extensively been used in R&D community and industry, most conventional protein microarrays rely on the complicated attachment chemistry and allow only one monolayer of antibodies or proteins attached on the substrate surface. The problem lies in that the density of the proteins attached this way can not be high, and in particular, not all proteins (enzymes, antibodies/antigens) remain functional in these conventional microarray formats due to the covalent linking process. Therefore, the sensitivities of the conventional protein microarrays are limited.

When proteins (antibodies, enzymes) are encapsulated, incorporated, entrapped, or intercalated between nanoparticles or nanosheets or sols and accordingly immobilized, these immobilized proteins maintain their activity and stability and can be dispersed in aqueous solution as a colloid, or colloidal immobilized protein, in an ink-like dispersion, Protein (Enzyme, or Antibody/Antigen) Ink. These protein inks, which are highly active and stable, can be easily applied to a working substrate, i.e, by printing, coating, spraying, pouring and combinations thereof. Such substrates may be those used in a variety of embodiments including for microarrays, biosensors, biochips, biomembranes, bioreactors, chemical reactors, and the like.

While various preferred embodiments of the invention have been shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A three-dimensional bio active coating comprising:
a deposition of performed immobilized protein inks; each of said preformed protein inks having at least one preselected protein immobilized and encapsulated within a plurality of nanoparticles.

2. The three-dimensional bioactive coating of claim 1 wherein said nanoparticles have dimensions in the range of 1-1000 nanometers.

3. The three-dimensional bioactive coating of claim 1 wherein said nanoparticles are porous.

4. The three dimensional bioactive coating of claim 1 wherein said nanoparticles are made from materials selected from the group consisting of mineral and synthesized clays, silica, metal oxides, metal hydroxides, metal salts, and combinations thereof.

5. The three dimensional bioactive coating of claim 4 wherein said clay is selected from the group of: Montmorillonite, Kaolinite, Palygorskite (attapulgite), Hectorite, Ripidolite, Rectorite, Laponite, Illite, Smectite, Ferruginous Smectite, Nontronite, Cookeite, Beidellite, Sepiolite, Saponite, Vermiculite, various synthesized clays and combinations thereof.

6. The three dimensional bioactive coating of claim 4 wherein said metal oxide nanoparticles are selected from, the group consisting of TiO₂, Fe₂O₃, V₂O₅, ZnO, Al₂O₃, MgO and combinations thereof.

7. The three dimensional bioactive coating of claim 4 wherein said metal oxide nanoparticles are selected from the group consisting of Fe(OH)₃, Zn(OH)₂, Al(OH)₃, Mg(OH)₂, and combinations thereof.

8. The three dimensional bioactive coating of claim 4 wherein said metal salt nanoparticles are selected from the group consisting of metal phosphates, metal silicates, metal sulfates, metal carbonates and combinations thereof.

9. The three dimensional bioactive coating of claim 1 wherein said nanoparticles have a generally uniform size.

10. The three dimensional bioactive coating of claim 1 wherein said nanoparticles have functional groups selected from the group consisting of —NH₂, —COOH, —SO₃H, —SH, —CN, —OH and combinations thereof

11. The three dimensional bioactive coating of claim 1 wherein said protein is selected from the group consisting of proteins, enzymes, antibodies, antigens, their respective complexes and combinations thereof.

12. An immobilized protein ink comprising a mixture of bioactive particles comprising said at least one protein immobilized and encapsulated within a plurality of nanoparticles; said encapsulated bioactive materials dispersed in a dispersing liquid.

13. The immobilized protein ink of claim 12 wherein said dispersing liquid is an aqueous buffer solution.

14. The immobilized protein ink of claim 13 wherein said dispersing liquid contains an additive selected from the group consisting of: polyamino acids, ionic surfactants, non-ionic surfactants, functional polymers, biomacromolecules and combinations thereof, or contains no such additives.

15. A substrate having a three dimensional coating deposition said coating deposition comprising at least one ink having at least one protein immobilized and encapsulated within a plurality of nanoparticles.

16. The substrate of claim 15 wherein said substrate is selected for the group consisting of microarrays, biosensors, biochips, biomembranes, bioreactors, chemical reactors, and combinations thereof.

17. A method for forming a three dimensional bioactive coating on a substrate, said method comprising the steps of:
applying a deposition of an immobilized protein ink having at least one protein immobilized and encapsulated within a plurality of nanoscaled particles upon said substrate.

18. The method of claim 17 wherein said application step is performed by a method selected from the group consisting of printing, coating, spraying, pouring and combinations thereof.
